(19) United States
(12) Patent Application Publication
(10) Pub. No.: US 2019/0318345 A1
(43) Pub. Date: Oct. 17, 2019

(54) METHOD AND SYSTEM FOR FACILITATING DESIGNATED PAYMENT TRANSACTION

(71) Applicant: Mastercard International Incorporated, Purchase, NY (US)

(72) Inventor: Manu Dharmaiah Kallugudde, Mumbai (IN)

(21) Appl. No.: 16/376,715

(22) Filed: Apr. 5, 2019

(30) Foreign Application Priority Data
Apr. 13, 2018 (SG) 10201803139U

(51) Int. Cl. G06Q 20/36; G06Q 20/40; G06Q 20/32

(52) U.S. Cl. CPC G06Q 20/3674; G06Q 20/40145; G06Q 2220/00; G06Q 20/3226; G06Q 20/3223

(57) ABSTRACT

Embodiments provide methods, and server systems for enabling usage of a payment card of a first user for making a payment transaction by an electronic device of a second user. In an embodiment, the method includes receiving, by a server system associated with a payment network, a tokenization request generated by the first user. The tokenization request at least includes a card information of the payment card and an identifier of the electronic device of the second user. The method includes facilitating an authorization of the tokenization request. Upon successful authorization of the tokenization request, the method includes generating a digital token including a tokenized card information of the payment card. Moreover, the method includes facilitating the digital token to the electronic device of the second user for making the payment transaction on behalf of the first user at a merchant interface.

### CROSS-REFERENCE TO RELATED APPLICATION

This application is a U.S. National Stage filing under 35 U.S.C. § 119, based on and claiming benefits of and priority to Singapore Patent Application No. 10201803139U filed on Apr. 13, 2018. The entire disclosure of the above application is incorporated herein by reference for all purposes

### TECHNICAL FIELD

The present disclosure relates to payment transactions from users to merchants and, more particularly to, a method and system for facilitating designated payment transaction performed based on tokenization of payment cards.

### BACKGROUND

Nowadays, most users use several banking cards, such as credit cards, debit cards, prepaid cards, etc., for performing financial transactions (e.g., payment transaction). The various banking cards are herein referred to as payment cards. The payment cards are increasingly used for making payments through various channels such as physical card swipe at point-of-sale (POS) terminals, contactless payments, Quick Response (QR) code payments etc. Digital payment industry is moving towards providing better user experience for both consumers and merchants. Consumers digitize the payment cards into the mobile phones, wearable devices etc., using technologies such as tokenization, Card-on-File (COF) transactions, digital wallets and the like. Tokenization allows consumer to digitize his/her existing payment cards into a mobile phone or other devices using a token and use the token at various merchant terminals.

In the scenarios when a user ‘John’ wants to pay on behalf of another user ‘Peter’ at a merchant terminal, John needs to use his own payment card for paying on behalf of Peter and to later get the transaction amount transferred from Peter. Alternatively, Peter has to share his payment card details with John for letting him use Peter's payment card for making Peter's payment transactions. Both of the above on-behalf payment transaction methods are cumbersome for both the users and also raise major security and trust issues such as payment card details being hacked or misused. Moreover, it becomes difficult for Peter to keep track of his financial spending if the sharing of the payment card details method is opted by him.

Accordingly, there is a need for techniques that enable safe on-behalf/designated payment transactions through the tokenization of the payment cards which gives users the choice and peace of mind to make more secure digital payments from a variety of merchant interfaces.

### SUMMARY

Various embodiments of the present disclosure provide systems, methods, electronic devices and computer program products to facilitate designated payment transactions.

In an embodiment, a method for enabling usage of a payment card of a first user for making a payment transaction by an electronic device of a second user is disclosed. The method includes receiving, by a server system associated with a payment network, a tokenization request generated by the first user. The tokenization request at least includes a card information of the payment card and an identifier of the electronic device of the second user. The method includes facilitating an authorization of the tokenization request. Upon successful authorization of the tokenization request, the method includes generating a digital token including a tokenized card information of the payment card. Moreover, the method includes facilitating the digital token to the electronic device of the second user for making the payment transaction on behalf of the first user at a merchant interface.

In another embodiment, a server system configured to enable usage of a payment card of a first user for making a payment transaction by an electronic device of a second user is provided. The server system includes a communication interface configured for receiving a tokenization request generated by the first user. The tokenization request at least includes a card information of the payment card and an identifier of the electronic device of the second user. The server system includes a memory comprising executable instructions and a processor communicably coupled to the communication interface. The processor is configured to execute the instructions to cause the server system to at least facilitate an authorization of the tokenization request. Upon successful authorization of the tokenization request, the server system is further caused to generate a digital token including a tokenized card information of the payment card. The server system is further caused to facilitate the digital token to the electronic device of the second user for making the payment transaction on behalf of the first user at a merchant interface.

In yet another embodiment, a server system configured to enable usage of a payment card of a first user for making a payment transaction by an electronic device of a second user is provided. The server system includes a database for storing a digital token including a tokenized card information of the payment card. The server system includes a communication interface configured to receive the digital token presented by the second user at a merchant interface. The server system includes a memory comprising executable instructions and a processor communicably coupled to the communication interface and the database. The processor is configured to execute the instructions to cause to the server system to validate the digital token. Upon successful validation of the digital token, the server system is caused to retrieve the card information of the payment card from the digital token. The server system is further caused to facilitate completion of the payment transaction by the second user on behalf of the first user upon successful authorization of the card information.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, related to at least some example embodiments of the present disclosure;

FIG. 2 represents a sequence flow diagram representing a generation of a digital token, in accordance with an example embodiment;

FIG. 3 represents a sequence flow diagram representing a completion of designated payment transaction using a digital token, in accordance with an example embodiment;

FIG. 4 is a simplified schematic representation of an example User Interface (UI) of a payment application in an electronic device for making a designated payment transaction through a contactless tap and pay transaction device, in accordance with an example embodiment;

FIG. 5 illustrates a flow diagram of a method for facilitating designated payment transaction, in accordance with an example embodiment;

FIG. 6 is a simplified block diagram of a server system configured to facilitate designated payment transaction, in accordance with one embodiment of the present disclosure;

FIG. 7 is a simplified block diagram of a token requestor server used for designated payment transaction, in accordance with one embodiment of the present disclosure;

FIG. 8 is a simplified block diagram of an issuer server for designated payment transaction, in accordance with one embodiment of the present disclosure;

FIG. 9 is a simplified block diagram of an acquirer server used for designated payment transaction, in accordance with one embodiment of the present disclosure;

FIG. 10 is a simplified block diagram of a payment server used for designated payment transaction, in accordance with one embodiment of the present disclosure; and

FIG. 11 shows simplified block diagram of a user device capable of implementing at least some embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refer to a financial account that is used to fund the financial transaction (interchangeably referred to as “payment transaction”). Examples of the payment account include, but is not limited to a savings account, a credit account, a checking account and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by PayPal®, and the like.

The term “payment network”, used throughout the description, refer to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

The term “payment card”, used throughout the description, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively, or additionally, the payment card may be embodied in form of data (e.g., a digital token) stored in a user device, where the data is associated with payment account such that the data can be used to process the financial transaction between the payment account and a merchant's financial account.

Overview

Various example embodiments of the present disclosure provide methods, systems, user devices and computer program products for facilitating designated payment transactions which enable usage of a payment card of a first user for making a payment transaction by an electronic device of a second user.

In various example embodiments, the present disclosure provides a server system configured to receive a tokenization request generated from a user device such as a mobile phone of the first user to tokenize a payment card linked with the first user. In one embodiment, the tokenization request may be generated using a payment application accessible on the user device of the first user as facilitated by a token requestor server (an example of the server system). Examples of the token requestor server include mobile banking applications, bank wallet applications, third-party wallet applications, payment gateways or any other Internet of Things (IoT) payment devices. The tokenization request includes a card information of the payment card of the first user and an identifier of the electronic device of the second user whom the first user wants to authorize for making an on-behalf/designated payment transaction. The tokenization request may also include additional information such as, but not limited to, a mobile number of the second user, a payment application identifier of the second user, a primary account number of the first user, an identification information of the second user, restrictions for the use of the token by the second user, and the like.

In one embodiment, the tokenization request is sent to an issuer server (an example of the server system) for authorization. The issuer server is configured to validate the card information and approve a transaction limit of the payment transaction, if the transaction limit is set by the first user. The issuer server notifies an interchange server (i.e. a payment server, an example of the server system) about successful validation of the tokenization request. The payment server generates a digital token for the payment card of the first user. The digital token includes safe and secure tokenized card information of the payment card. In a non-limiting example, the payment server may replace the payment card's primary account number (e.g., the 16-digit number present on the physical payment card) with a unique alternate card number that is called a token/digital token.

In one embodiment, the digital token is sent to the electronic device (e.g., a mobile phone) of the second user whom the first user wants to authorize to make a designated payment transaction at a merchant interface. The digital token is sent using the identifier of the electronic device received with the tokenization request. The second user can use the digital token for mobile point-of-sale transactions, in-app purchases, online purchases, contactless tap and pay transactions and the like on behalf of the first user. For example, the digital token can be represented at a contactless tap and pay transaction device (an example of the merchant interface) using the electronic device of the second user. The merchant interface sends the digital token to an acquirer server (an example of the server system) associated with an acquirer bank of the merchant.

The acquirer server sends the digital token to the payment server for validation. The payment server validates the digital token and retrieves the underlying card information of the tokenized payment card for sending to the issuer server for authorization. The payment server may also send the transaction amount to the issuer server to verify sufficient funds present in an issuer account of the first user. Once, the payment server receives confirmation of authorization of the card information from the issuer server, the payment server facilitates the designated payment transaction from the issuer account of first user to the merchant account using the digital token presented by the second user.

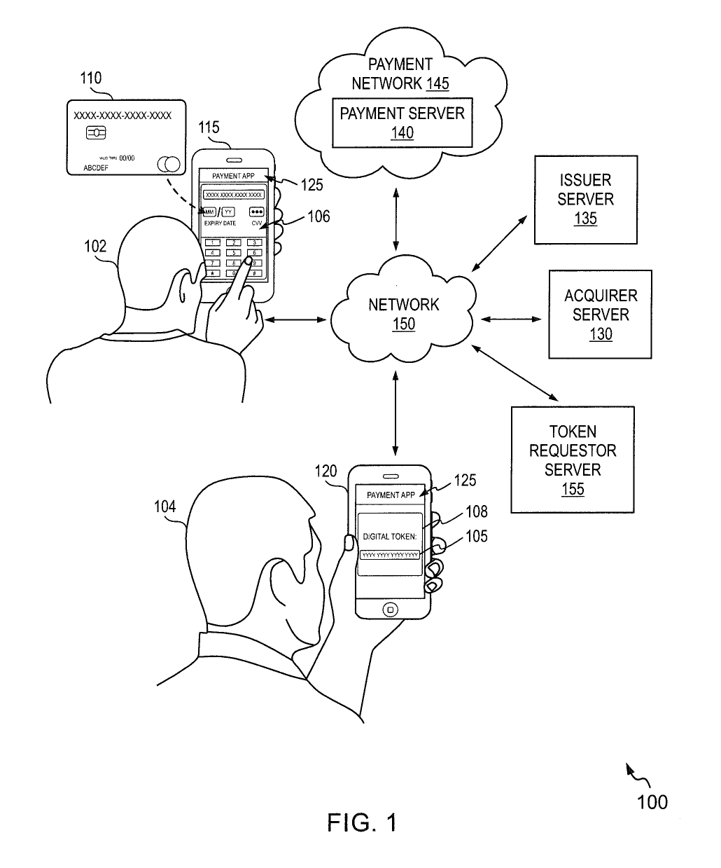

FIG. 1 illustrates an example representation of an environment 100, in which at least some example embodiments of the present disclosure can be implemented. A user 102 (hereinafter referred to as a first user 102) is shown using his user device 115 (i.e., a mobile phone). Examples of the user device 115 include, but are not limited to, a personal computer (PC), a mobile phone, a tablet device, a Personal Digital Assistant (PDA), a voice activated assistant, a Virtual Reality (VR) device, a smartphone and a laptop. A payment application 125 is shown running on the user device 115 using which the first user 102 generates a tokenization request of tokenizing a payment card 110. The payment application 125 is shown to display various form fields 106 to be filled by the first user 102 such as a payment card number (e.g., xxxx xxxx xxxx xxxx where ‘x’ is an integral number) of the payment card 110, expiry date (e.g., MM/YY, month and year of expiry), Card Verification Value (CVV) number (e.g., *** where * is an integral number) and the like. The form fields 106 may collectively be referred to hereinafter as a card information 106 of the payment card 110. Alternatively, the card information 106 may include information such as cardholder's payment account number, or any identification number associated with the payment card 110.

Various embodiments of the present disclosure provide mechanisms such that the first user 102 is only required to tokenize his payment card 110 to generate a digital token using which a second user 104 can make a payment transaction on behalf of the first user 102 at various merchant interfaces. To achieve this, the payment application 125 may display a UI (not shown in FIG. 1) through which the first user 102 is requested to enter an identifier of an electronic device 120 (e.g., a mobile phone) of the second user 104. Examples of the electronic device 120 include, but are not limited to, a personal computer (PC), a mobile phone, a tablet device, a Personal Digital Assistant (PDA), a voice activated assistant, a Virtual Reality (VR) device, a smartphone and a laptop. Device identifiers are unique identifiers which can be used to identify the electronic device 120. Some non-exhaustive examples of the identifiers include, but not limited to, International Mobile Equipment Identity (IMEI), Mobile Equipment Identifier (MEID), Google ID, Apple ID, Samsung ID, mobile phone number, Media Access Control address (MAC address) and the like.

The payment application 125 is shown to be running on the electronic device 120. An information field 108 is displayed by the payment application 125 depicting a digital token 105 (hereinafter referred to as a token 105, exemplarily represented as yyyy yyyy yyyy yyyy where y is an integral number) sent to the electronic device 120 of the second user 104 for the designated payment transactions. The token 105 is sent using the identifier of the electronic device 120 received with the tokenization request generated by the first user 102. The token 105 includes a tokenized card information of the payment card 110 of the first user 102. In a non-limiting example, the token 105 is a numeric code of variable length (13 to 19 digits).

In a non-limit example, the process of tokenization of the payment card 110 and completion of the designated payment transaction is facilitated by a combination of a token requestor server 155, a payment server 140, an issuer server 135 and an acquirer server 130. In one embodiment, the payment server 140 is associated with a payment network 145. The payment network 145 may be used by the payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data between financial institutions that are members of Mastercard International Incorporated®. (Mastercard is a registered trademark of Mastercard International Incorporated located in Purchase, N.Y.). Further, Mastercard Digital Enablement Service (MDES) is a service/a tokenization platform facilitated by Mastercard® payment system interchange network that allows issuers, registered users, token requestors and merchants to turn the payment card numbers into digital tokens for secure digital payment transactions.

The token requestor server 155 is associated with a token requestor which needs to register with a token service provider (e.g., the payment server 140/MDES) in order to request generation of the digital tokens. Examples of token requestor include mobile banking applications, bank wallet applications, third-party wallet applications, payment gateways and the like. Digital wallet platforms such as Apple pay®, Samsung pay®, Google pay Microsoft Wallet etc., provide mobile and web applications (e.g., the payment application 125) using which the users (e.g., the first user 102) can generate the tokenization request of their payment cards (e.g., the payment card 110) as well as use the generated digital tokens (e.g., the token 105) for digital payments at the merchant interfaces. Additionally, the token requestor server 155 may be configured to generate cryptograms to be associated with the generated digital tokens for enhanced security of digital payments.

In one example embodiment, the token requestor server 155 may store the payment application 125 and provision instances of the application to end-users (such as the first user 102 and the second user 104) on their respective user devices for facilitating the token generation request. The end-users may request the token requestor server 155 to provision access to the payment application 125 over a network 150. The instances of the application may thereafter be downloaded on the user devices (such as the user device 115 and the electronic device 120) of the respective end-users in response to their request for access to the application. Alternatively, in some embodiments, the application may be factory installed within the user devices associated with the end-users and, as such, the users may not need to explicitly request the application from the token requestor server 155.

The issuer server 135 is associated with a financial institution normally called as an “issuer bank” or “issuing bank” or simply “issuer”, in which the first user 102 may have an account, which issues a payment card, such as a credit card or a debit card. The issuer server 135 also facilitates authorization of the tokenization request received from the first user 102.

To accept payment using the token 105 based payment transaction from the second user 104 on behalf of the first user 102, the merchant (not shown) must normally establish an account with a financial institution that is part of the financial payment system. This financial institution is usually called the “merchant bank” or the “acquiring bank” or “acquirer bank” or simply “acquirer”. The acquirer server 130 is associated with the acquirer bank.

Using the payment network 145, the computers of the acquirer/the acquirer server 130 or the merchant processor communicate with the computers of the issuer/the issuer server 135 to determine whether the first user's account is in good standing and whether the purchase is covered by the first user's available account balance. Based on these determinations, authorization of the payment transaction is declined or accepted. When the authorization is accepted, the available balance of the first user's account is decreased. Normally, a charge is not posted immediately to a user's account because bankcard associations, such as Mastercard International Incorporated®, have promulgated rules that do not allow a merchant to charge, or “capture,” a transaction until goods are shipped or services are delivered. When the merchant ships or delivers the goods or services, the merchant captures the transaction by, for example, appropriate data entry procedures on the point-of-sale (POS) terminal. If a user cancels a transaction before it is captured, a “void” is generated. If the user returns goods after the transaction has been captured, a “credit” is generated.

After a transaction is captured, the transaction is settled between the merchant, the acquirer and the issuer. Settlement refers to the transfer of financial data or funds between the merchant's account, the acquirer, and the issuer, related to the transaction. Usually, transactions are captured and accumulated into a “batch”, which is settled as a group.

The user device 115 and the electronic device 120, a merchant device (e.g., the contactless tap and pay transaction device, not shown) associated with the merchant interface (not shown in FIG. 1), the issuer server 135, the acquirer server 130, the token requestor server 155 and the payment server 140 communicate with one another using the network 150. Examples of the network 150 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 150 may be or include the Internet, intranets, extranets, microwave networks, satellite communications, cellular systems, personal communication services (“PCS”), infrared communications, global area networks, or other suitable networks, etc., or any combination of two or more such networks.

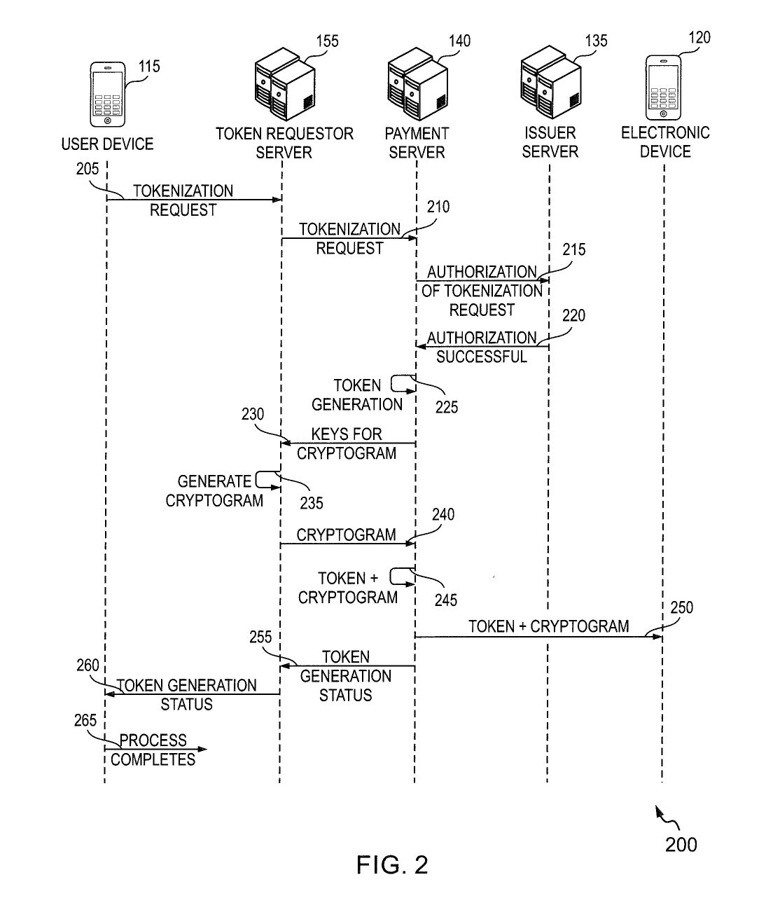

Since the second user 104 is needed to only receive the token 105 for making a payment to the merchant on behalf of the first user 102, the overall transaction flow is effortless for completing the payment transaction for both the users. In existing (conventional) payment transaction methods (i.e., not in accordance with the present disclosure), the first user 102 is either required to share the card information 106 of the payment card 110 with the second user 104 or later transfer the transaction amount to the second user 104. In contrast to existing payment transaction methods, by using the embodiments of the present disclosure, the first user 102 is only once required to tokenize his choice of the payment card which is shared with the second user 104 for making designated payments. Hence, both the users need not worry about keeping the track of transaction amount transfers. Some non-exhaustive example embodiments of completing designated payment transactions using digital tokens are described with reference to the following description, particularly with reference to FIGS. 2 to 4.

FIG. 2 represents a sequence flow diagram 200 representing the generation of the token 105, in accordance with an example embodiment of the present disclosure.

At 205, a user (e.g., the first user 102), upon accessing the website and/or the payment application 125 accessible on his user device (e.g., a user device 115), is presented with one or more UIs displayed (not shown) on a display screen of the user device 115 to send a tokenization request of a payment card (e.g., the payment card 110) to the token requestor server 155. As explained with reference to FIG. 1, the tokenization request further includes identifier of the electronic device 120 being used by the second user 104. The tokenization request may also include limitations for the use of the token by the second user 104, for example an expiration date, a limit to the number of transactions, a limit for the transaction amount (i.e., individual transaction limit defined by the first user 102) or the accumulated transaction amounts (i.e., overall transaction limit defined by the first user 102), a merchant name based restriction (e.g., a restriction on certain merchants by defining merchant names), a merchant category code based restriction (a restriction on certain merchants by defining one or more merchant category codes), and the like.

At 210, the token requestor server 155 sends the tokenization request to the payment server 140 for tokenization of the payment card 110. The tokenization request may also include identification information of the second user 104 whom the first user 102 wants to authorize for making designated payment transaction. At 215, the payment server 140 sends the tokenization request to the issuer server 135 for authorization. Authorization of the card information 106 of the payment card 110 is performed by the issuer server 135. The authorization process includes validating the card information 106 of the payment card 110. A transaction limit of the payment transaction is also approved by the issuer server 135, if the transaction limit is set by the first user 102. Further, verification of the cardholder identification is performed by the issuer server 135. The issuer server 135 may also store the identification information of the second user 104 for later retrieval. At 220, the issuer server 135 notifies the payment server 140 of the successful authorization of the tokenization request as well as verification of the cardholder (e.g., the first user 102).

At 225, the payment server 140 is configured to generate a digital token (e.g., the token 105) that includes a tokenized card information of the payment card 110 or any other funding source of the first user 102. Token values vary in format and may be cryptographically or non-cryptographically generated. Further, the token format may be a PAN-formatted replacement value based on a designated token Bank Identification Number (BIN) or token card range. Further, a single PAN may be mapped to multiple tokens for different scenarios.

If compromised or stolen, tokens reduce the likelihood of subsequent fraud since they have no value outside a specific device, merchant or acceptance channel. Further, the usage of the token 105 can be restricted based on multiple criteria such as assigning the token 105 to a specific device, channel, merchant or geographic location or a combination of these to restrict the transaction within that domain. For example, the tokenization request of the first user 102 may include a user preference of one-time token generation that is valid to be used by the second user 104 only for one designated payment transaction. Alternatively, the first user 102 may include a user preference of recurrent use of the token 105 by the authorized second user 104 for a fixed number of times or on a permanent basis.

The generated tokens and the original PANs they map to are stored securely in a database of the payment server 140 and the mapping is used during the de-tokenization process i.e. during a payment transaction. Such database of the payment server 140 may also store any limitations or restrictions for the use of the token 105 as defined by the first user 102. In an embodiment, the issuer server 135 is configured to send an activation code to the user device 115 of the first user 102 which upon being entered in the payment application 125 activate the usage of the tokenized payment card for making digital payment transactions. The payment server 140 is further configured to continually manage the token through suspension, deletions, updates, etc. Additionally, the payment server 140 is configured to generate a set of keys appropriate for the generation of a cryptogram to be associated with the token 105 and send the set of keys to the token requestor server 155 (see, 230).

At 235, the token requestor server 155 generates the cryptogram using the set of keys sent by the payment server 140. In an example embodiment, the token 105 with the cryptogram is generated by considering information of originating card holder i.e. the first user 102 and the token receiving party i.e. the second user 104. In another example embodiment, the cryptogram/the dynamic data may be generated using EMV®-based cryptography to secure the designated payment transaction. For example, in place of an account PAN of the first user 102, the cryptogram may be accompanied by a 16-digit token such that the use of a token rather than a PAN minimizes the impact of account data compromise. In an alternate embodiment, the payment server 140 may be configured to generate the cryptogram using EMV®-based cryptography to secure the payment transaction.

At 240, the cryptogram is sent to the payment server 140 from the token requestor server 155. At 245, the payment server 140 is configured to associate the cryptogram with the token 105. At 250, the payment server 140 sends the token 105 and the associated cryptogram to the electronic device 120 of the second user 104. It is noted that the token 105 includes the cryptogram as a part and may not be separately sent for making designated payment transactions. As explained above, the tokenization request includes device identifier of the electronic device 120 which is stored in the database of the payment server 140. Upon generation of the token 105, the payment server 140 sends the token 105 to the electronic device 120 using the device identifier retrieved from the database.

At 255, the payment server 140 sends the status of the generation of the token 105 to the token requestor server 155. The status may include notification about successful, failed or pending token generation. At 260, the token requestor server 155 further sends the token generation status to the user device 115 of the first user 102. The token generation process completes at operation 265.

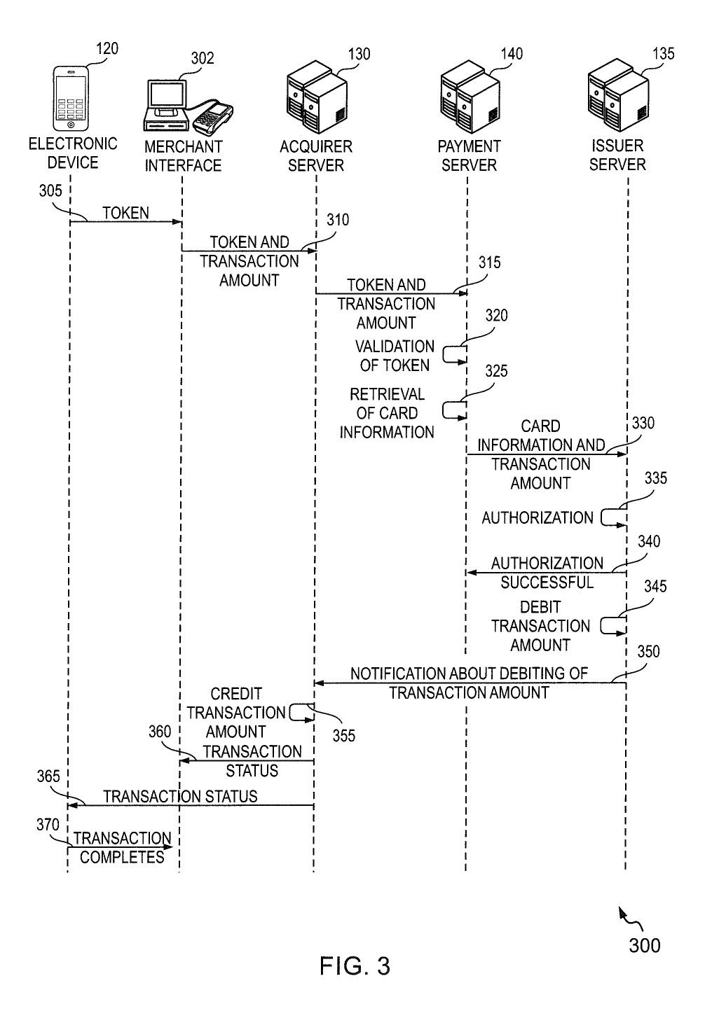

FIG. 3 represents a sequence flow diagram 300 representing a completion of designated payment transaction using a digital token, in accordance with an example embodiment of the present disclosure. As explained with reference to operation 250 of FIG. 2, the payment server 140 sends the token 105 including the associated cryptogram to the electronic device 120 of the second user 104 using the identifier of the electronic device 120 which is stored in the database of the payment server 140. In an embodiment, the token 105 is used by the second user 104 for making the designated payment transaction at a merchant interface on behalf of the first user 102.

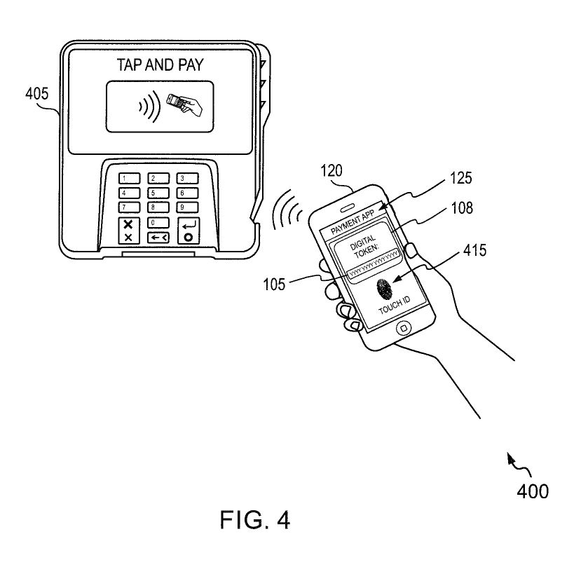

At 305, the second user 104 sends the received token 105 using the payment application 125 running on the electronic device 120 to a merchant interface 302. Examples of the merchant interface 302 include a POS terminal, a contactless tap and pay transaction device, merchant telephone, merchant computer system and the like. Alternatively or additionally, the merchant interface 302 can also be an online merchant interface such as a merchant website, mobile or desktop applications, or third party websites or applications using which the consumer/second user 104 may purchase goods or service from a remote location or with in-store presence. Communication between the electronic device 120 and the merchant interface 302 is explained in detail later with reference to FIG. 4.

At 310, the merchant interface 302 sends the token 105 and a transaction amount to the acquirer server 130 for further processing. Alternatively, the second user 104 can enter a transaction amount (e.g., $50) to be paid for performing the financial transaction using the merchant interface 302 or the payment application 125. The transaction amount may be determined by scanning products that are bought at a merchant facility (not shown). Alternatively, the electronic device 120 may be equipped with some suitable applications to scan the bar code or price tag so as to be able to decide upon the transaction amount.

At 315, the acquirer server 130 sends the token 105 and the transaction amount to the payment server 140 for validation. The acquirer server 130 also determines the acquirer account of the merchant and sends the acquirer account details to the payment server 140. At 320, the payment server 140 validates the token 105 by mapping the token 105 to its associated cardholder PAN (i.e., PAN of the first user 102) stored in the database. Further, the payment server 140 identifies the merchant using the acquirer details received from the acquirer server 130 for facilitating completion of the designated payment transaction.

At 325, the payment server 140 retrieves the card information 106 of the payment card 110 from the token 105 through de-tokenization process. The payment server 140 further validates the cryptogram associated with the token 105 and validates if the requested payment transaction is in line with any transaction limitations or restrictions for the use of the token 105 as stored in the database of the payment server 140. If any of the validations fails, the payment server 140 rejects the transaction and notifies the acquirer server 130 accordingly. In an embodiment, the payment server 140 is configured to store the token 105 and the associated payment credentials such as the card information 106, device identifier of the electronic device 120 and the like in a cloud storage.

At 330, the retrieved card information 106 and the transaction amount are sent to the issuer server 135 for authorization. At 335, the issuer server 135 performs authorization of the payment card 110 and transaction amount by verifying the card information 106 of the payment card 110, available balance amount in the cardholder account against the received transaction amount, Mobile Personal Identification Number (MPIN), issuer account information and the like. Some non-exhaustive examples of the issuer account information include Bank Identifier Code (BIC), account number, payment card number and the like.

At 340, the issuer server 135 notifies the payment server 140 of the successful authorization of the payment card 110, the first user 102 and the transaction amount. At 345, the issuer server 135 debits the transaction amount from the first user's account. At 350, the issuer server 135 sends a notification of debiting of the transaction amount to the acquirer server 130 via the payment network 145. At 355, the acquirer server 130 credits the transaction amount in the merchant account. At 360, the acquirer server 130 sends the transaction status to the merchant interface 302. The transaction status may include successful, failure or pending. At 365, the acquirer server 130 sends the transaction status to the electronic device 120 of the second user 104. Alternatively, the transaction status may be sent by the merchant interface 302 to the electronic device 120. The transaction process completes at operation 370.

Thus, a designated or on-behalf payment transaction flow as explained with reference to FIG. 3 provides the end consumers a better user experience as compared to conventional techniques. Since, only the token 105 flows through the various channels, it prevents misuse of the card information 106. Further, as the first user 102 is provided with a facility to restrict the number of transactions (or for the total amount) the token 105 can be used by the second user 104, he does not need to worry about the misuse of the balance amount available in his issuer account.

FIG. 4 illustrates a simplified schematic representation 400 of usage of the electronic device 120 of the second user 104 for making a designated payment transaction through a contactless tap and pay transaction device 405 (hereinafter referred to as a tap and pay device 405), in accordance with an example embodiment of the present disclosure. As shown in the payment application 125 in the electronic device 120, an information field 108 includes a representation of the token 105 (exemplarily represented as yyyy yyyy yyyy yyyy, where y is an integral number). Since the token 105 appears as a new card number, the recognition of a returning customer is performed based on the customer's device (e.g., the second user 104) to which the token is sent. The UI 400 further displays a touch ID exemplarily represented with a biometric icon 415 (e.g., a fingerprint). In at least one example embodiment, the electronic device 120 includes a Near Filed Communication (NFC) chip configured to facilitate contactless payment transaction with the tap and pay device 405 of the merchant at a merchant facility (not shown). Examples of the merchant facility may include any retail shop, supermarket or establishment, government and/or private agencies, ticket counters, or any such place or establishment where users visit for performing financial transaction in exchange of any goods and/or services or any transaction that requires financial transaction between the user and the facility.

In an embodiment, the second user 104 is requested to provide a biometric authentication using the biometric icon 415. Biometric authentication can be performed using face recognition, fingerprint scan, retina scan, iris scan, voice analysis, and the like. Alternatively, the second user 104 may be requested to enter a Personal Identification Number (PIN) of the electronic device 120 for user authentication. Such two-factor authentication, 1) identifying the electronic device 120 using the device identifier and 2) identifying the second user 104 using biometric/PIN authentication adds to the security levels of the designated payment transaction. Further, as the token 105 is tied/sent only to the device to be used for payment transaction, the token 105 cannot be used to pay through another device even if it gets stolen.

In an example embodiment, if the second user 104 wants to use the token 105 on a merchant e-commerce mobile application/web site (another example of the merchant interface 302), the second user 104 can click on a button ‘click to pay’ (not shown) provided by the merchant application using the UI on the electronic device 120. The merchant server sends the token 105 and the transaction amount to the mobile wallet application (type of a token requestor server 155 where the user has stored the payment cards in digital format) using the mobile wallet Application Program Interfaces (APIs). The merchant application redirects the user to another UI facilitated by the wallet server/token requestor server 155 for payment using the token 105. Further, the merchant server sends the token 105 to the acquirer server 130 for further processing. Thereafter, operations 315 to 370 as explained with reference to FIG. 3 are performed by various server systems to complete the designated payment transaction. For example, the payment server 140 validates the token 105 and sends the card information 106 retrieved from the token 105 to the issuer server 135 for authorization. The issuer server 135 verifies whether the first user's payment account (i.e. the issuer account) is in good standing and whether the prospective purchase is covered by the user's available credit line or account balance. If the account holds enough balance amount, the issuer server 135 debits the exact number of transaction amount from the account and notifies the payment server 140 and the acquirer server 130 of successful authorization. The payment transaction completes with security against theft and simplicity using card-less on-behalf transactions.

In another example embodiment, an existing POS terminal present at the merchant facility may be upgraded to facilitate tap and pay transactions using the NFC technology. To achieve this, the POS terminal may be provided with an operating system and various software applications that can provide various functionalities to the POS terminal. For example, in some embodiments, the POS terminal may be addressable with an Internet protocol and may include a browser application. In such embodiments, the POS terminal includes software adapted to support such functionality. In some embodiments, the POS terminal executes software to support network management. In particular, this capacity allows software to be downloaded to a plurality of such systems to provide new applications such as application for enabling tokenized payment transactions using POS terminals and/or updates to existing applications. The operating system and software application upgrades may be distributed and maintained through communication to the POS terminal over a communication network, such as the network 150 of FIG. 1.

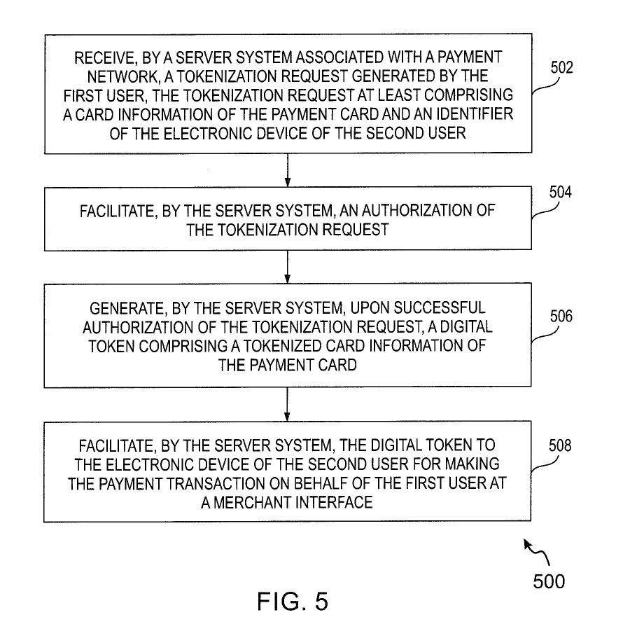

FIG. 5 illustrates a flow diagram of a method 500 for facilitating designated payment transaction, in accordance with an example embodiment. More specifically, the method 500 for enabling usage of a payment card of a first user for making a payment transaction by an electronic device of a second user using a digital token is disclosed. The method 500 depicted in the flow diagram may be executed by, for example, the at least one server system such as the acquirer server 130, the issuer server 135, the token requestor server 155 and the payment server 140 explained with reference to FIG. 1. Operations of the flow diagram 500, and combinations of operation in the flow diagram 500, may be implemented by, for example, hardware, firmware, a processor, circuitry and/or a different device associated with the execution of software that includes one or more computer program instructions. The operations of the method 500 are described herein with help of the server systems 130, 135, 155 or 140. It is noted that the operations of the method 500 can be described and/or practiced by using a system other than these server systems. The method 500 starts at operation 502.

At 502, the method 500 includes receiving, by a server system (e.g., the token requestor server 155) associated with a payment network, a tokenization request generated by a first user. The tokenization request at least includes a card information of the payment card and an identifier of the electronic device of the second user. In an embodiment, the token requestor server 155 is configured to facilitate a payment application accessible on a user device of the first user to generate the tokenization request. The token requestor server 155 may send the tokenization request to the payment server 140 over the payment network 145.

At 504, the method 500 includes, facilitating, by the server system (e.g., the issuer server 135), an authorization of the tokenization request.

At 506, the method 500 includes generating, by the server system (e.g., the payment server 140), a digital token including a tokenized card information of the payment card upon successful authorization of the tokenization request by the issuer server 135.

At 508, the method 500 includes facilitating, by the server system, the digital token to the electronic device of the second user for making the payment transaction on behalf of the first user at a merchant interface. In an embodiment, the payment server 140 is configured to send the digital token to the token requestor server 155 which further sends the digital token to the electronic device of the second user. Alternatively, the digital token is sent using the payment application accessible on the user device of the first user to the electronic device of the second user. It should be appreciated that the operations 502-508 are performed without the need of the first user to share the card information of his payment card with the second user to carry out an on-behalf payment transaction. Since the second user is only required to send the token to the merchant interface, and the server systems are required to map the token with the PAN of the first user, the overall time and steps needed to complete the payment transaction reduces adequately. Such arrangement further leads to more secure payment transactions and better user experience for both the users.

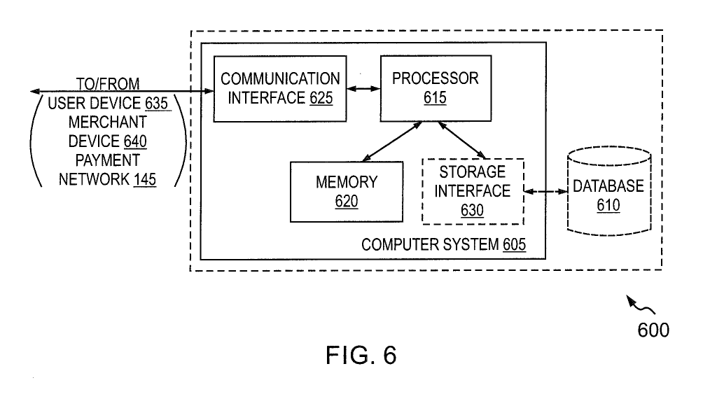

FIG. 6 is a simplified block diagram of a server system 600 configured to facilitate designated payment transaction, in accordance with one embodiment of the present disclosure. The server system 600 is an example of a server system that is a part of the payment network 145. Examples of the server system 600 includes, but not limited to, the acquirer server 130, the issuer server 135, the token requestor server 155 and the payment server 140. The server system 600 includes a computer system 605 and a database 610.

The computer system 605 includes at least one processor 615 for executing instructions. Instructions may be stored in, for example, but not limited to, a memory 620. The processor 615 may include one or more processing units (e.g., in a multi-core configuration).

The processor 615 is operatively coupled to a communication interface 625 such that the computer system 605 is capable of communicating with a remote device such as a merchant device 640 (e.g., the tap and pay device 405 or any other the merchant interface 302) or a user device 635 (e.g., the user device 115 and the electronic device 120) or communicating with any entity within the payment network 145. For example, the communication interface 625 may receive the tokenization request from the user device 635 (i.e., the user device 115 of the first user 102), via the Internet.

The processor 615 may also be operatively coupled to the database 610. The database 610 is any computer-operated hardware suitable for storing and/or retrieving data, such as, but not limited to, transaction data generated as part of sales activities conducted over the bankcard network including data relating to merchants, account holders or customers, and purchases. The database 610 may also store information related to a plurality of user's payment accounts. Each user account data includes at least one of a user name, a user address, an account number, PIN, and other account identifiers. The database 610 may also store device identifiers and the digital tokens. The database 610 may also store a merchant identifier that identifies each merchant registered to use the payment network, and instructions for settling transactions including merchant bank account information (e.g., a plurality of payment accounts related to the merchant interfaces associated with merchants). The database 610 may further include issuer account information. The database 610 may include multiple storage units such as hard disks and/or solid-state disks in a redundant array of inexpensive disks (RAID) configuration. The database 610 may include a storage area network (SAN) and/or a network attached storage (NAS) system.

In some embodiments, the database 610 is integrated within the computer system 605. For example, the computer system 605 may include one or more hard disk drives as the database 610. In other embodiments, the database 610 is external to the computer system 605 and may be accessed by the computer system 605 using a storage interface 630. The storage interface 630 is any component capable of providing the processor 615 with access to the database 610. The storage interface 630 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 615 with access to the database 610.

The processor 615 is configured to generate a unique digital token based on authorization of the tokenization request received via the communication interface 625. The authorization of the tokenization request may also be performed by the processor 615 by validating the tokenization request i.e., a card information of the payment card using the associated card information stored in the database 610. The processor 615 is further configured to approve the transaction amount by verifying against the available balance in the issuer account of the user, as stored in the database 610. The processor 615 is configured to send the digital token to the user device 635 (e.g., the electronic device 120 of the second user 104) via the communication interface 625 for facilitating completion of the designated payment transaction. The processor 615 is configured to notify the user device 635 and the merchant device 640 of the transaction status via the communication interface 625.

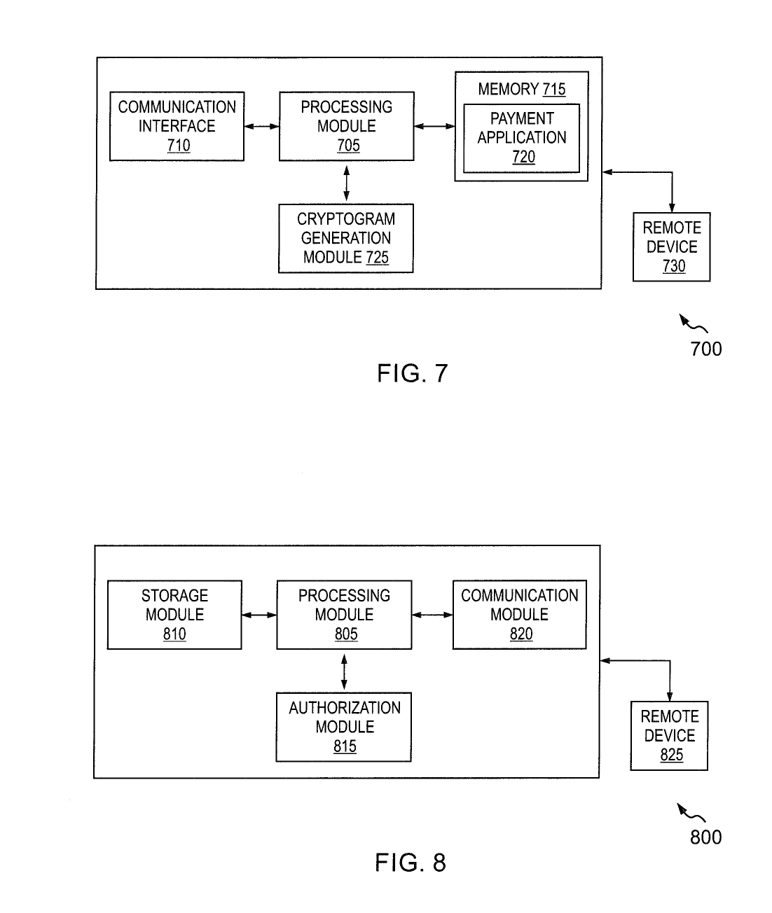

FIG. 7 is a simplified block diagram of a token requestor server 700 used for designated payment transaction, in accordance with one embodiment of the present disclosure. The token requestor is an example of third party wallet application configured to provide its registered users storage of their payment cards on digital platform so as to make card-less payments. The token requestor server 700 is an example of the token requestor server 155 of FIG. 1. The token requestor server 700 includes at least one processing module 705 communicably coupled to a communication interface 710, at least one memory 715 and a cryptogram generation module 725. In at least one embodiment, the token requestor server 700 may be accessible to remote devices, such as a remote device 730, through a communication network, such as the network 150 or the payment network 145.

The processing module 705 is capable of executing the stored machine executable instructions of a payment application 720 (e.g., the payment application 125) in the memory 715 or within the processing module 705 or any storage location accessible to the processing module 705. The processing module 705 is configured to perform the various operations as explained with reference to method 500. For example, the processing module 705 is configured to receive the tokenization request from a user device of a first user via the communication interface 710 and forward it to the payment server 140 for the tokenization of the payment card selected by the first user. The processing module 705 is configured to store the card information of the payment card for facilitating the first user to make digital payment transactions using the stored card information. The processing module 705, in conjunction with, the cryptogram generation module 725 is configured to generate cryptogram to be associated with the token using the set of keys sent by the payment server 140. The cryptogram generation module 725 is configured to include various cryptographic algorithms that can be used by the processing module 705 to generate the cryptogram.

In an embodiment, the processing module 705 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like

In an embodiment, the token requestor server 700 may include an input/output module (I/O module) (not shown) configured to receive inputs from and provide outputs to the end-user (i.e. the merchant and/or the users such as the first user 102 and the second user 104) of the payment application 720. For instance, the I/O module may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 715 can be any type of storage accessible to the processing module 705. The memory 715 includes program instructions for facilitating the payment application 720. For example, the memory 715 may include volatile or non-volatile memories, or a combination thereof. In some non-limiting examples, the memory 715 can be four to sixty-four Megabytes (MB) of Dynamic Random Access Memory (“DRAM”) or Static Random Access Memory (“SRAM”). In addition, some examples may include supplementary flash memory installed via a PCMCIA slot.

The communication interface 710 is further configured to cause display of user interfaces on the remote device 730. In one embodiment, the communication interface 710 includes a transceiver for wirelessly communicating information to, or receiving information from, the remote device 730 or other suitable display device, and/or another type of remote processing device. In another embodiment, the communication interface 710 is capable of facilitating operative communication with the remote devices and a cloud server using Application Program Interface (API) calls. The communication may be achieved over a communication network, such as the network 150.

FIG. 8 is a simplified block diagram of an issuer server 800 for designated payment transaction, in accordance with one embodiment of the present disclosure. The issuer server 800 is an example of the issuer server 135 of FIG. 1, or may be embodied in the issuer server 135. The issuer server 800 is associated with an issuer bank/issuer, in which a user may have an account. The issuer server 800 includes a processing module 805 operatively coupled to a storage module 810, an authorization module 815, and a communication module 820. The components of the issuer server 800 provided herein may not be exhaustive, and that the issuer server 800 may include more or fewer components than that of depicted in FIG. 8. Further, two or more components may be embodied in one single component, and/or one component may be configured using multiple sub-components to achieve the desired functionalities. Some components of the issuer server 800 may be configured using hardware elements, software elements, firmware elements and/or a combination thereof.

The storage module 810 is configured to store machine executable instructions to be accessed by the processing module 805. Additionally, the storage module 810 stores information related to, contact information of the first user, identification information of the second user, bank account number, BICs, payment card details, internet banking information, PIN, mobile personal identification number (MPIN) for mobile banking and the like. The PIN 215 is a four-digit identification code issued by the issuer bank of the user while registering for electronic payment transactions or while issuing the payment card to the user. For example, the PIN 215 may be issued for swipe based transactions, mobile banking, internet banking, payment string based transaction and the like. The PIN is needed to be verified for authentication of the user's identity and association with the issuer bank to process the payment transaction. This information is retrieved by the processing module 805 for cross-verification during payment transactions.

The processing module 805, in conjunction with the authorization module 815, is configured to validate the card information received from the payment server 140 via the communication module 820. Additionally, the processing module 805 is configured to verify the PIN (e.g., whether the four-digit numeric code matches the PIN issued by the issuer), the sufficient funds in the issuer account and the like. Upon successful authorization of the card information and the cardholder only, the payment transaction is processed further by the processing module 805 by debiting the transaction amount from the issuer account of the user. The processing module 805 is further configured to communicate with one or more remote devices such as a remote device 825 using the communication module 820 over a network such as the network 150 or the payment network 145 of FIG. 1. The examples of the remote device 825 include, the merchant device 640, the user device 635, the payment server 140, the acquirer server 130, the token requestor server 700, other computing systems of issuer and the payment network 145 and the like. The communication module 820 is capable of facilitating such operative communication with the remote devices and cloud servers using API (Application Program Interface) calls.

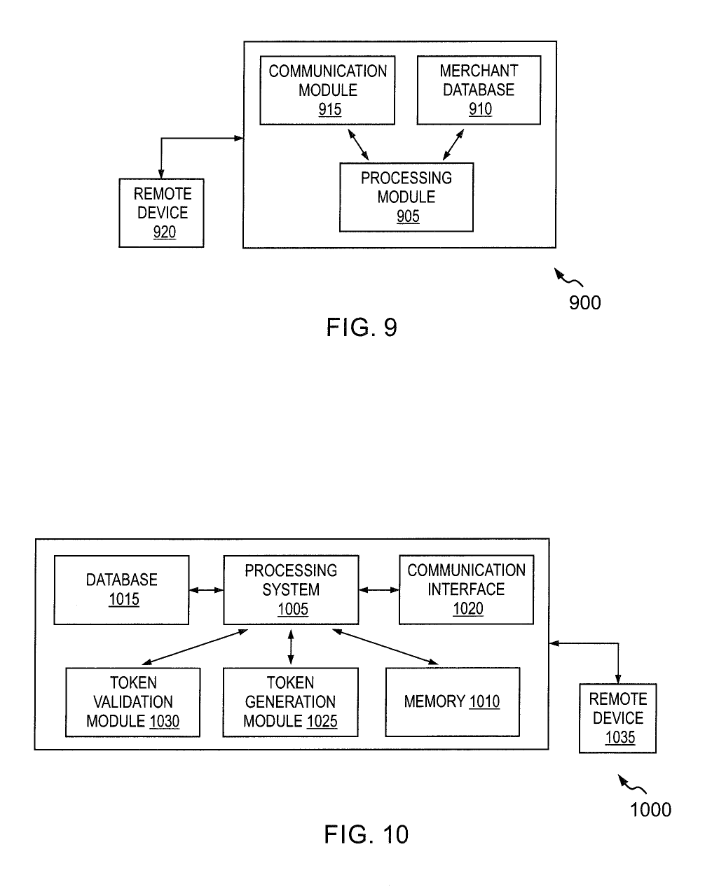

FIG. 9 is a simplified block diagram of an acquirer server 900 used for designated payment transaction, in accordance with one embodiment of the present disclosure. The acquirer server 900 is associated with the acquirer bank of a merchant where the merchant has established an account to accept payment using the digital token. The acquirer server 900 is an example of the acquirer server 130 of FIG. 1, or may be embodied in the acquirer server 130. Further, the acquirer server 900 is configured to facilitate the digital token based payment transaction with the issuer server 800 using the payment network 145 of FIG. 1. The acquirer server 900 includes a processing module 905 communicably coupled to a merchant database 910 and a communication module 915. The components of the acquirer server 900 provided herein may not be exhaustive, and that the acquirer server 900 may include more or fewer components than that of depicted in FIG. 9. Further, two or more components may be embodied in one single component, and/or one component may be configured using multiple sub-components to achieve the desired functionalities. Some components of the acquirer server 900 may be configured using hardware elements, software elements, firmware elements and/or a combination thereof.

The merchant database 910 includes data related to merchant, such as, but not limited to, a merchant primary account number (PAN), a merchant name, a merchant category code (MCC), a merchant city, a merchant postal code, a merchant brand name, a merchant ID and the like. The processing module 905 is configured to use the merchant ID to identify the merchant during the normal processing of payment transactions, adjustments, chargebacks, end-of-month fees and so forth. The merchant ID is different than other merchant account numbers, particularly those that identify merchants to the equipment (e.g., the POS terminals or any other merchant electronic devices) they use for processing transactions. A merchant with a single merchant processing account number may use several terminals at one location, resulting in one merchant ID and several terminal identification numbers (TIDs). The processing module 905 may be configured to store and update such merchant information in the merchant database 910 for later retrieval.

In an embodiment, the communication module 915 is capable of facilitating operative communication with a remote device 920 (e.g., the issuer server 800, the merchant device 640, the token requestor server 700 and/or the payment server 140) using API calls. The communication may be achieved over a communication network, such as the network 150. For example, the processing module 905 may receive the token and the transaction amount from the merchant device 640 (e.g., the tap and pay device 405) using the communication module 915. Further, the processing module 905 is configured to receive the debited transaction amount from the payment server 140 or the issuer server 135 (or the issuer server 800) using the communication module 915. Thereafter, the processing module 905 may retrieve merchant PAN from the merchant database 910 to credit the transaction amount in the acquirer account of the merchant. Further, the processing module 905 may be configured to send the transaction status to the merchant device 640 of the merchant and the user device 635 (e.g., the electronic device 120 of the second user 104).

FIG. 10 is a simplified block diagram of a payment server 1000 used for designated payment transaction, in accordance with one embodiment of the present disclosure. The payment server 1000 may correspond to the payment server 140 of FIG. 1. As explained with reference to FIG. 1, the payment server 140 is associated with a payment network 145. The payment network 145 may be used by the token requestor server 700, the issuer server 800 and the acquirer server 900 as a payment interchange network. Examples of the payment interchange network include, but not limited to, Mastercard® payment system interchange network. The payment server 1000 includes a processing system 1005 configured to extract programming instructions from a memory 1010 to provide various features of the present disclosure. The components of the payment server 1000 provided herein may not be exhaustive, and that the payment server 1000 may include more or fewer components than that of depicted in FIG. 10. Further, two or more components may be embodied in one single component, and/or one component may be configured using multiple sub-components to achieve the desired functionalities. Some components of the payment server 1000 may be configured using hardware elements, software elements, firmware elements and/or a combination thereof.

Via a communication interface 1020, the processing system 1005 receives a tokenization request from a remote device 1035 such as the user device 115 of the first user 102 of FIG. 1. The communication may be achieved through API calls, without loss of generality. A token generation module 1025 is operatively coupled to the processing system 1005. The token generation module 1025 includes one or more algorithms capable of generating the token. Further, a token validation module 1030 that may include a predefined rule set to be used for validation of the token received at the time of payment transaction. The token may be received from a remote entity such as the acquirer server 900 via the communication interface 1020. The validation of the token is performed based on mapping the token with the associated PAN of the first user as stored in a database 1015. The database 1015 may also store the identification information of the second user, device identifier of the electronic device being used by the second user to make the payment transaction, PIN, the transaction amount, acquirer account information, transaction records, merchant account information, and the like. Apart from the token generation and validation, the processing system 1005 may be configured to perform various functions such as maintenance and operation of the database 1015, token issuance and token provisioning, token domain restriction controls (e.g., the same token may be used for a Mobile NFC at Point of Sale transaction and also used in another transaction at an e-commerce website), token requestor IDs generation and the like.

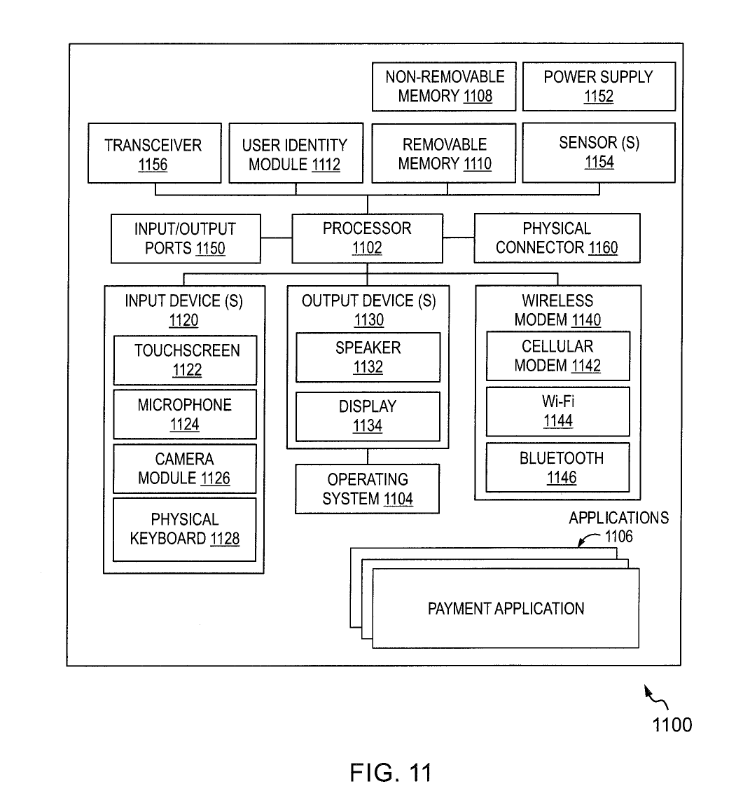

FIG. 11 shows simplified block diagram of a user device 1100 for example a mobile phone or a desktop computer capable of implementing the various embodiments of the present disclosure. For example, the user device 1100 may correspond to the user device 635 (e.g., the user device 115 of the first user 102 or the electronic device 120 of the second user 104 of FIG. 1) of FIG. 6. The user device 1100 is depicted to include one or more applications such as a payment application 1106 which is an example of the payment application 125. The payment application 1106 can be an instance of an application downloaded from any of the servers 130, 135, 155 and 140. The payment application 1106 is capable of communicating with any of the servers 130, 135, 155 and 140 and the merchant interface 302 for facilitating designated payment transactions using the tokenization of the payment card.

It should be understood that the user device 1100 as illustrated and hereinafter described is merely illustrative of one type of device and should not be taken to limit the scope of the embodiments. As such, it should be appreciated that at least some of the components described below in connection with that the user device 1100 may be optional and thus in an example embodiment may include more, less or different components than those described in connection with the example embodiment of the FIG. 11. As such, among other examples, the user device 1100 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 1100 includes a controller or a processor 1102 (e.g., a signal processor, microprocessor, ASIC, or other control and processing logic circuitry) for performing such tasks as signal coding, data processing, image processing, input/output processing, power control, and/or other functions. An operating system 1104 controls the allocation and usage of the components of the user device 1100 and support for one or more payment transaction applications programs (see, the applications 1106) such as the payment application, that implements one or more of the innovative features described herein. In addition, the payment application, the applications 1106 may include common mobile computing applications (e.g., telephony applications, email applications, calendars, contact managers, web browsers, messaging applications) or any other computing application.

The illustrated user device 1100 includes one or more memory components, for example, a non-removable memory 1108 and/or removable memory 1110. The non-removable memory 1108 and/or the removable memory 1110 may be collectively known as a database in an embodiment. The non-removable memory 1108 can include RAM, ROM, flash memory, a hard disk, or other well-known memory storage technologies. The removable memory 1110 can include flash memory, smart cards, or a Subscriber Identity Module (SIM). The one or more memory components can be used for storing data and/or code for running the operating system 1104 and the applications 1106. The user device 1100 may further include a user identity module (UIM) 1112. The UIM 1112 may be a memory device having a processor built in. The UIM 1112 may include, for example, a subscriber identity module (SIM), a universal integrated circuit card (UICC), a universal subscriber identity module (USIM), a removable user identity module (R-UIM), or any other smart card. The UIM 1112 typically stores information elements related to a mobile subscriber. The UIM 1112 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 1100 can support one or more input devices 1120 and one or more output devices 1130. Examples of the input devices 1120 may include, but are not limited to, a touch screen/a display screen 1122 (e.g., capable of capturing finger tap inputs, finger gesture inputs, multi-finger tap inputs, multi-finger gesture inputs, or keystroke inputs from a virtual keyboard or keypad), a microphone 1124 (e.g., capable of capturing voice input), a camera module 1126 (e.g., capable of capturing still picture images and/or video images) and a physical keyboard 1128. Examples of the output devices 1130 may include, but are not limited to a speaker 1132 and a display 1134. Other possible output devices can include piezoelectric or other haptic output devices. Some devices can serve more than one input/output function. For example, the touch screen 1122 and the display 1134 can be combined into a single input/output device.

A wireless modem 1140 can be coupled to one or more antennas (not shown in the FIG. 13) and can support two-way communications between the processor 1102 and external devices, as is well understood in the art. The wireless modem 1140 is shown generically and can include, for example, a cellular modem 1142 for communicating at long range with the mobile communication network, a Wi-Fi compatible modem 1144 for communicating at short range with an external Bluetooth-equipped device or a local wireless data network or router, and/or a Bluetooth-compatible modem 1146. The wireless modem 1140 is typically configured for communication with one or more cellular networks, such as a GSM network for data and voice communications within a single cellular network, between cellular networks, or between the user device 1100 and a public switched telephone network (PSTN).

The user device 1100 can further include one or more input/output ports 1150, a power supply 1152, one or more sensors 1154 for example, an accelerometer, a gyroscope, a compass, or an infrared proximity sensor for detecting the orientation or motion of the user device 1100 and biometric sensors for scanning biometric identity of an authorized user, a transceiver 1156 (for wirelessly transmitting analog or digital signals) and/or a physical connector 1160, which can be a USB port, IEEE 1294 (FireWire) port, and/or RS-232 port. The illustrated components are not required or all-inclusive, as any of the components shown can be deleted and other components can be added.

The disclosed method with reference to FIG. 5, or one or more operations of the flow diagram 500 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server systems 130, 135, 155 and 140 its various components such as the computer system 605 and the database 610 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY®Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A method of enabling usage of a payment card of a first user for making a payment transaction by an electronic device of a second user, the method comprising:
receiving, by a server system associated with a payment network, a tokenization request generated by the first user, the tokenization request at least comprising a card information of the payment card and an identifier of the electronic device of the second user;
facilitating, by the server system, an authorization of the tokenization request;
upon successful authorization of the tokenization request, generating, by the server system, a digital token comprising a tokenized card information of the payment card; and
facilitating, by the server system, the digital token to the electronic device of the second user for making the payment transaction on behalf of the first user at a merchant interface.

2. The method as claimed in claim 1, wherein the server system is a payment server and wherein the method further comprises:
receiving the digital token presented by the second user at the merchant interface via an acquirer server, wherein the merchant interface is a contactless tap and pay transaction device;
validating the digital token;
upon successful validation of the digital token, retrieving the card information of the payment card from the digital token;
sending the retrieved card information and a transaction amount to an issuer server for authorization; and
facilitating completion of the payment transaction by the second user on behalf of the first user upon successful authorization of the card information and the transaction amount.

3. The method as claimed in claim 2, wherein facilitating completion of the payment transaction further comprises:
performing authentication of the second user based at least on verification of any one of:
a biometric information of the second user; and
a personal identification number (PIN) of the electronic device of the second user.

4. The method as claimed in claim 1, wherein the server system is a payment server and wherein receiving the tokenization request by the first user comprises:
receiving the tokenization request from a token requestor server, the token requestor server configured to facilitate a payment application accessible on a user device of the first user to generate the tokenization request.

5. The method as claimed in claim 4, further comprising:
sending the digital token, by the payment server, to the token requestor server, the token requestor server configured to send the digital token to the electronic device of the second user.

6. The method as claimed in claim 4, further comprising:
sending the digital token using the payment application accessible on the user device of the first user to the electronic device of the second user.

7. The method as claimed in claim 1, wherein facilitating the authorization of the tokenization request comprises:
validating the card information of the payment card by an issuer server; and
approving a transaction limit of the payment transaction by the issuer server, if the transaction limit is set by the first user.

8. The method as claimed in claim 1, wherein the tokenization request further comprises at least one of: a mobile number of the second user; a payment application identifier of the second user; a primary account number of the first user; an identification information of the second user; and restrictions for the use of the token by the second user.

9. The method as claimed in claim 8, wherein the restrictions for the use of the token by the second user comprise at least one of: an expiration date; a limit to a number of transactions; a limit for a transaction amount; a limit for accumulated transaction amounts; a restriction on certain merchants by defining merchant names; and a restriction on certain merchants by defining one or more merchant category codes.

10. The method as claimed in claim 1, wherein generating the digital token further comprises:
associating a cryptogram with the digital token.

11. A server system in a payment network for enabling usage of a payment card of a first user for making a payment transaction by an electronic device of a second user, the server system comprising:
a communication interface for receiving a tokenization request generated by the first user, the tokenization request at least comprising a card information of the payment card and an identifier of the electronic device of the second user;
a memory comprising executable instructions; and
a processor communicably coupled to the communication interface and configured to execute the instructions to cause the server system to at least:
facilitate an authorization of the tokenization request;
upon successful authorization of the tokenization request, generate a digital token comprising a tokenized card information of the payment card; and
facilitate the digital token to the electronic device of the second user for making the payment transaction on behalf of the first user at a merchant interface.

12. The server system as claimed in claim 11, wherein the server system is a payment server and wherein the server system is further caused to:
receive the digital token presented by the second user at the merchant interface via an acquirer server, wherein the merchant interface is a contactless tap and pay transaction device;
validate the digital token; and
upon successful validation of the digital token, retrieve the card information of the payment card from the digital token;
send the retrieved card information and a transaction amount to an issuer server for authorization; and
facilitate completion of the payment transaction by the second user on behalf of the first user upon successful authorization of the card information and the transaction amount.

13. The server system as claimed in claim 12, wherein for facilitating completion of the payment transaction, the server system is caused to:
perform authentication of the second user based at least on verification of any one of:
a biometric information of the second user, and
a personal identification number (PIN) of the electronic device of the second user.

14. The server system as claimed in claim 11, wherein the server system is a payment server and wherein for receiving the tokenization request by the first user, the server system is further caused to:
receive the tokenization request from a token requestor server, the token requestor server configured to facilitate a payment application accessible on a user device of the first user to generate the tokenization request.

15. The server system as claimed in claim 14, wherein the server system is further caused to:
send the digital token, by the payment server, to the token requestor server, the token requestor server configured to send the digital token to the electronic device of the second user.

16. The server system as claimed in claim 14, wherein the server system is further caused to:
send the digital token using the payment application accessible on the user device of the first user to the electronic device of the second user.

17. The server system as claimed in claim 11, wherein for facilitating the authorization of the tokenization request, the server system is caused to:
validate the card information of the payment card by an issuer server; and
approve a transaction limit of the payment transaction by the issuer server, if the transaction limit is set by the first user.

18. The server system as claimed in claim 11, wherein the tokenization request further comprises at least one of: a mobile number of the second user; a payment application identifier of the second user; a primary account number of the first user; an identification information of the second user; and restrictions for the use of the token by the second user.

19. The server system as claimed in claim 18, wherein the restrictions for the use of the token by the second user comprise at least one of: an expiration date; a limit to a number of transactions; a limit for a transaction amount; a limit for accumulated transaction amounts; a restriction on certain merchants by defining merchant names; and a restriction on certain merchants by defining one or more merchant category codes.

20. The server system as claimed in claim 11, wherein for generating the digital token, the server system is caused to:
associate a cryptogram with the digital token.

21. A server system in a payment network for enabling usage of a payment card of a first user for making a payment transaction by an electronic device of a second user, the server system comprising:
a database for storing a digital token comprising a tokenized card information of the payment card;
a communication interface for receiving the digital token presented by the second user at a merchant interface;
a memory comprising executable instructions; and
a processor communicably coupled to the communication interface and the database, the processor configured to execute the instructions to cause the server system to:
validate the digital token;
upon successful validation of the digital token, retrieve the card information of the payment card from the digital token;
facilitate completion of the payment transaction by the second user on behalf of the first user upon successful authorization of the card information.

22. The server system as claimed in claim 21, wherein the server system is caused to: send the retrieved card information to an issuer server for authorization.
